(19) United States
(12) Patent Application Publication
(10) Pub. No.: US 2014/0164237 A1
(43) Pub. Date: Jun. 12, 2014

(54) METHOD AND SYSTEM FOR SHARING AND DISTRIBUTING CONTENT DURING A CONSUMER EXPERIENCE

(71) Applicant: MASTERCARD INTERNATIONAL INCORPORATED, Purchase, NY (US)

(72) Inventors: Germán BLANCO, London (GB); Colin TANNER, Uxbridge (GB); Theresa L. SMITH, Park Street (GB)

(73) Assignee: MasterCard International Incorporated, Purchase, NY (US)

(21) Appl. No.: 13/710,922

(22) Filed: Dec. 11, 2012

(51) Int. Cl. G06Q 20/32

(52) U.S. Cl. CPC G06Q 20/322
USPC 705/44

(57) ABSTRACT

A method for funding and sharing an experience includes: reading a code encoded with an identifier; transmitting the identifier; receiving details for a transaction, the details including a transaction amount; displaying the amount to a consumer; receiving an indication of transaction options; transmitting the transaction options for processing the transaction; receiving an indication of transaction approval; and displaying a prompt to share experience information with a social network. A method for distributing content includes: storing details for a transaction, the details including an identifier, an amount, and a stage; receiving a content request including an identification; identifying specific details where the identifier corresponds to the identification; transmitting content based on the stage included in the specific details where if the stage indicates the transaction is to be processed the content includes the amount included in the specific details; and receiving an indication of approval of the financial transaction.

### FIELD

The present disclosure relates to the initiation and processing of a consumer experience using a mobile communication device, specifically receiving transaction details from a server upon scanning a machine-readable code for initiating of a transaction, sharing experience information, and receiving content during the consumer experience.

### BACKGROUND

Some personal service providers, such as restaurants, provide goods or services to a consumer prior to receiving payment. In such instances, especially in the restaurant industry, the goods or services may have been provided and the consumer fully satisfied prior to even receiving the bill. In this type of scenario, a consumer will often indicate that he or she is ready for the bill, wait for the employee to provide them with the bill, receive the bill, furnish payment information, wait for the employee to take the bill, wait for the employee to process the payment, and then wait for the employee to return with change or a receipt that requires the consumer to sign. This can be a long, arduous process where the consumer must wait several times, despite being ready to leave at the outset.

Some service providers have developed services to attempt to increase the efficiency for initiating and processing such a transaction. Some restaurants and service providers may have computer terminals at a table or booth, from which the consumer may request the bill and then provide payment. However, such terminals may be limited in the transaction options provided to the consumer, and often will require that the employee first “deliver” the bill to the terminal to enable the initiation of the transaction, which also requires the consumer to wait on the employee.

Other service providers may provide transaction details to a consumer via a machine-readable code printed on a receipt. The consumer may scan the code with a mobile device, view the details, and select transaction options. However, like traditional methods, the consumer is still required to wait on the employee to receive the machine-readable code to scan. In addition, the timing and presentation of the code is such that it cannot efficiently provide additional content or details to the consumer.

Thus, there is a need for a technical solution to initiating and processing a financial transaction using a mobile device that is more efficient and provides for the distribution of additional content to the mobile device and the sharing of the consumer experience.

### SUMMARY

The present disclosure provides a description of a systems and methods for funding and sharing a consumer experience and the distribution of content to a mobile device during the consumer experience.

A method for funding a sharing a consumer experience includes: reading, by a reading device, a machine-readable code encoded with at least a location identifier; decoding, by a decoding device, the machine-readable code to obtain the encoded location identifier; transmitting, by a transmitting device, the location identifier to a server; receiving, by a receiving device, transaction details for a financial transaction to be processed, wherein the transaction details include at least a transaction amount; displaying, by a display device, the transaction details for the financial transaction to be processed to a consumer; receiving, by an input device, an indication of selected transaction options; transmitting, by the transmitting device, the selected transaction options for processing of the financial transaction; receiving, by the receiving device, an indication of approval of the financial transaction; and displaying, by the display device, a prompt to the consumer to share experience information with at least one social network.

A method for distributing content during an ongoing transaction includes: storing, in a database, transaction details for a financial transaction to be processed, wherein the transaction details include at least a transaction identifier, a transaction amount, and a stage identifier; receiving, by a receiving device, a request for content, wherein the request for content includes at least a transaction identification; identifying, in the database, specific transaction details wherein the included transaction identifier corresponds to the transaction identification; transmitting, by a transmitting device, content to be received by a mobile communication device, wherein the content is based on the stage identifier included in the specific transaction details, and wherein, if the stage identifier indicates that the financial transaction is to be processed, the content includes at least the transaction amount included in the specific transaction details; and receiving, by a receiving device, an indication of approval of the financial transaction.

A system for funding and sharing a consumer experience includes a reading device, a decoding device, a transmitting device, a receiving device, a display device, and an input device. The reading device is configured to read a machine-readable code encoded with at least a location identifier. The decoding device is configured to decode the machine-readable code to obtain the encoded location identifier. The transmitting device is configured to transmit the location identifier to a server. The receiving device is configured to receive transaction details for a financial transaction to be processed, wherein the transaction details include at least a transaction amount. The display device is configured to display the transaction details for the financial transaction to be processed to a consumer. The input device is configured to receive the selected transaction options for processing of the financial transaction. The transmitting device is further configured to transmit the selected transaction options for processing of the financial transaction. The receiving device is further configured to receive an indication of approval of the financial transaction. The display device is further configured to display a prompt to the consumer to share experience information with at least one social network.

A system for distributing content during an ongoing transaction includes a database, a receiving device, a processing device, and a transmitting device. The database is configured to store transaction details for a financial transaction to be processed, wherein the transaction details include at least a transaction identifier, a transaction amount, and a stage identifier. The receiving device is configured to receive a request for content, wherein the request for content includes at least a transaction identification. The processing device is configured to identify, in the database, specific transaction details wherein the included transaction identifier corresponds to the transaction identification. The transmitting device is configured to transmit content to be received by a mobile communication device, wherein the content is based on the stage identifier included in the specific transaction details, and wherein, if the stage identifier indicates that the financial transaction is to be processed, the content includes at least the transaction amount included in the specific transaction details. The receiving device is further configured to receive an indication of approval of the financial transaction.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for distribution of content in, funding of, and sharing of a consumer experience in accordance with exemplary embodiments.

FIG. 2 is a block diagram illustrating a mobile device for use in the system of FIG. 1 in accordance with exemplary embodiments.

FIG. 3 is a block diagram illustrating a merchant server for use in the system of FIG. 1 in accordance with exemplary embodiments.

FIG. 4 is a block diagram illustrating a transaction database of the merchant server of FIG. 3 in accordance with exemplary embodiments.

FIGS. 5A and 5B are a processing flow illustrating a method for distributing content and processing a transaction in accordance with exemplary embodiments.

FIG. 6 is a flow chart illustrating a method for distributing content to a mobile device in an ongoing transaction in accordance with exemplary embodiments.

FIGS. 7A-7F are illustrations of a graphical user interface of the mobile device of FIG. 2 in accordance with exemplary embodiments.

FIG. 8 is a block diagram illustrating system architecture of a computer system in accordance with exemplary embodiments.

FIG. 9 is a flow chart illustrating an exemplary method for funding and sharing a consumer experience in accordance with exemplary embodiments.

FIG. 10 is a flow chart illustrating an exemplary method for distributing content during an ongoing transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Funding, Sharing, and Providing Content in a Consumer Experience

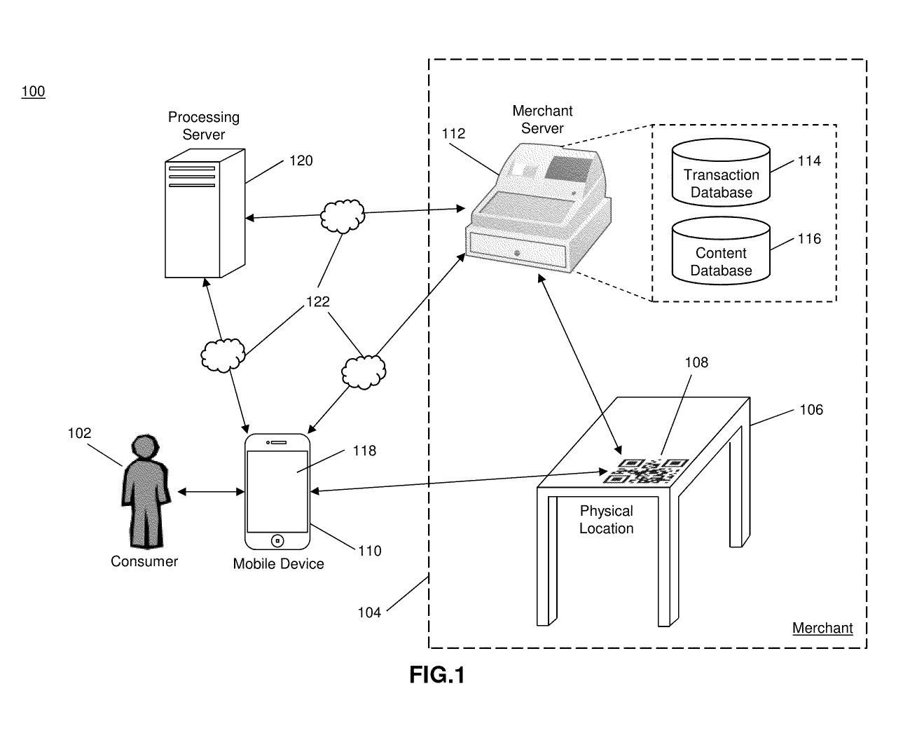

FIG. 1 is a block diagram illustrating a system 100 for the funding and sharing of a consumer experience and the distribution of content during the ongoing experience.

The system 100 may include a consumer 102, who many possess a mobile device 110. The mobile device 110, discussed in more detail below, may be any type of mobile communication device suitable for performing the functions disclosed herein as will be apparent to persons having skill in the relevant art, such as a cellular phone, smart phone, tablet computer, netbook computer, laptop computer, etc. The mobile device 110 may include a display 118 to display information to the consumer 102.

The consumer 102 may visit a service provider, such as a merchant 104, to purchased goods or services. The merchant 104 may be a restaurant or other service provider that provides goods or services to the consumer 102 in exchange for compensation. In an exemplary embodiment, the consumer 102 and the merchant 104 may participate in an ongoing transaction, such as furnishing a meal to the consumer 102.

The consumer 102 may be seated at a physical location 106 at the merchant 104, such as a table, a booth, a bar, etc. A machine-readable code 108 may be displayed at the physical location 106. Methods for display of the machine-readable code 108 at the physical location 106 will be apparent to persons having skill in the relevant art and may include displaying a placard including the machine-readable code 108, affixing the machine-readable code 108 to the physical location 106 itself, displaying the machine-readable code 108 on a display screen located at the physical location 106, etc. The machine-readable code 108 may be encoded with a location identifier, which may be associated with the physical location 106. In one embodiment, only a single machine-readable code 108 displayed at the merchant 104 may be encoded with a specific location identifier.

The merchant 104 may also include a merchant server 112. The merchant server 112 may be a server configured to perform the functions as disclosed herein and discussed in more detail below. The merchant server 112 may include a transaction database 114 and a content database 116. The transaction database 114, discussed in more detail below, may be configured to store transaction information for a financial transaction. The content database 116 may include content to be distributed to a mobile device, such as the mobile device 110 of the consumer 102. The merchant server 112 may be a point-of-sale system, such as legacy point-of-sale systems used by service providers for initiating and processing financial transactions.

The system 100 may further include a processing server 120, which may be configured to process financial transactions. The processing server 120 may be part of a financial transaction processing agency, such as MasterCard, VISA, etc., and may process financial transactions involving the merchant 104 and the consumer 102 using systems and methods that will be apparent to persons having skill in the relevant art, such as the traditional four party payment processing system.

The processing server 120, the merchant server 112, and the mobile device 110 may each be configured to communicate via a network 122. The network 122 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

### Mobile Communication Device

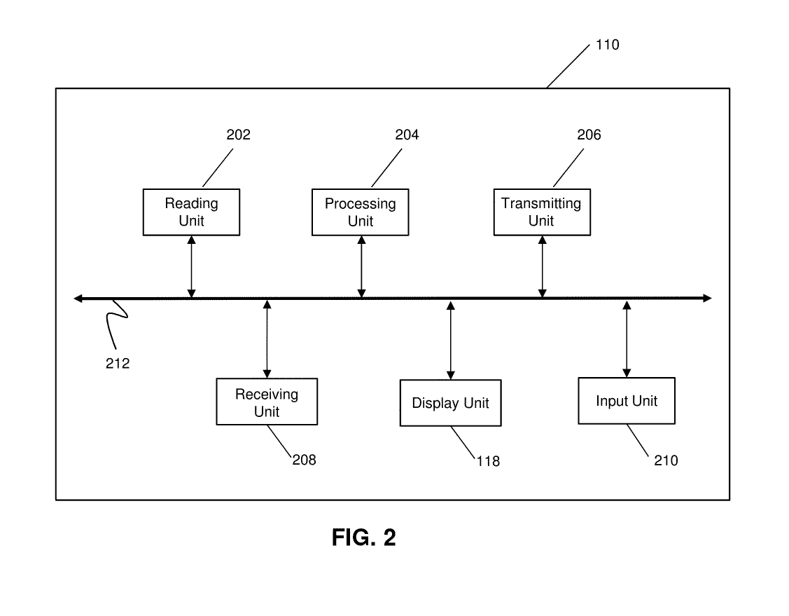

FIG. 2 illustrates an embodiment of the mobile device 110 for funding and sharing a consumer experience and receiving content in an ongoing consumer experience.

The mobile device 110 may include a reading unit 202, a processing unit 204, a transmitting unit 206, a receiving unit 208, a display unit 118, and an input unit 210. Each of the components may be configured to communicate via a bus 212. Suitable types and configurations of the bus 212 will be apparent to persons having skill in the relevant art.

The reading unit 202 may be configured to read the machine-readable code 108. In one embodiment the machine-readable code 108 may be a bar code. In a further embodiment, the bar code may be a QR code, but nearly any suitable machine readable code could be used, whether optical, near field or other wireless based machine readable format. The reading unit 202 may be any type of device suitable for reading the machine-readable code 108, such as a camera or other imaging device, or wireless RF, magnetic field reader, etc. The processing unit 204 may be configured to decode the machine-readable code 108 to identify the encoded location identifier corresponding to the physical location 106.

The transmitting unit 206 may be configured to transmit the location identifier to the merchant server 112 (e.g., via the network 122). In response to the transmission of the location identifier, the receiving unit 208 may receive transaction details or content from the merchant server 112. Content received from the merchant server 112 may be displayed on the mobile device 110 via the display unit 118. Content received from the merchant server 112 may be based on the status of the ongoing consumer experience, as discussed in more detail below. The display unit 118 may be any type of display suitable for displaying transaction details and received content, such as a liquid crystal display (LCD), a light-emitting diode (LED) display, a thin film transistor (TFT) display, a capacitive touch display, etc.

The transaction details received by the receiving unit 208 may include at least a transaction amount for the financial transaction. In some embodiments, the transaction details may further include at least one product or service to be purchased and an associated amount. The display unit 118 may be configured to display the received transaction details to the consumer 102. The input unit 210 may be configured to receive input of selected transaction options from the consumer 102. The selected transaction options may be options for the funding and/or processing of the financial transaction and may be dependent on the transaction and the circumstances. For example, the selected transaction options may include funding information (e.g., a payment card number), a tip amount to be added to the transaction amount when processing the financial transaction, or an approval of the transaction amount. The input unit 210 may be any type of input device suitable for performing the functions as disclosed herein, such as a keyboard, a click wheel, a stylus, a capacitive touch display, etc.

The transmitting unit 206 may be further configured to transmit the selected transaction options to the merchant server 112, which may then initiate processing of the financial transaction. The receiving unit 208 may be further configured to receive a receipt or notification of the processing of the financial transaction from the merchant server 112 and/or the processing server 120, which may then be displayed by the display unit 118. In an exemplary embodiment, the display unit 118 may display a prompt for the consumer 102 to share their consumer experience with at least one social network following the receipt of the indication that the transaction has been processed.

In a further embodiment, the input unit 210 may receive input of experience information, and the transmitting unit 206 may be configured to transmit the experience information to at least one selected social network. The experience information may include any information related to the consumer experience as will be apparent to persons having skill in the relevant art, such as a rating, a review, an identification of at least one employee involved in the transaction, photos, etc.

### Merchant Server

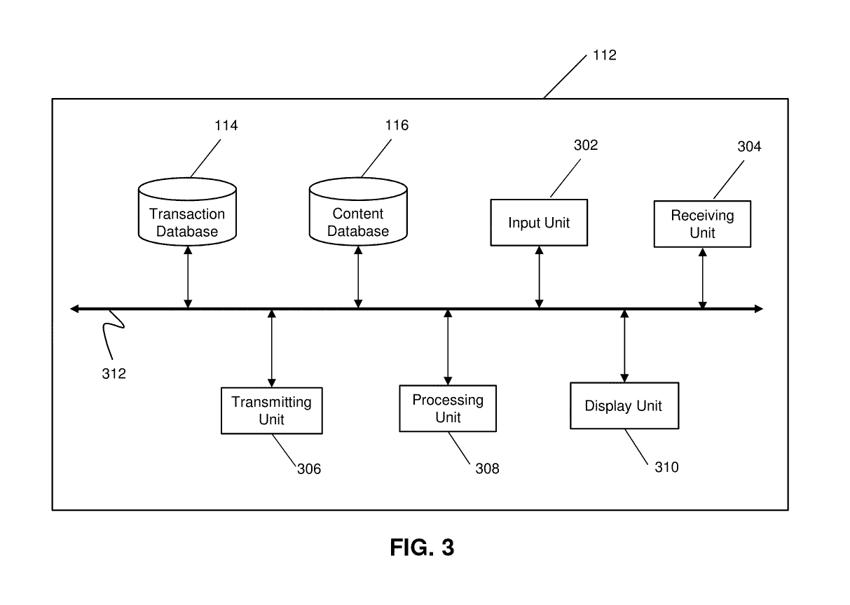

FIG. 3 illustrates an embodiment of the merchant server 112 for providing transaction information and ongoing content distribution to the mobile device 110 during a consumer experience.

The merchant server 112 may include the transaction database 114, the content database 116, an input unit 302, a receiving unit 304, a transmitting unit 306, a processing unit 308, and a display unit 310. Each of the components may be configured to communicate via a bus 312. Suitable types and configurations of the bus 312 will be apparent to persons having skill in the relevant art. Data stored in the transaction database 114 and the content database 116 (the “databases”) may be stored on any type of suitable computer readable media, such as optical storage (e.g., a compact disc, digital versatile disc, Blu-ray disc, etc.), semiconductor storage (e.g., flash drive), magnetic storage (e.g., a hard disk drive), etc. The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 122).

The transaction database 114 may be configured to store transaction information, as discussed in more detail below, such as a transaction amount and a transaction stage. The transaction amount may be the amount owed by the consumer 102 for the furnished goods and/or services. The transaction stage may be an indication of the phase of the transaction for the distribution of content to the mobile device 110. The content database 116 may be configured to store content for distribution to the mobile device 110. Types of content that may be stored in the content database 116 and distributed to the mobile device 110 will be apparent to persons having skill in the relevant art and may include web pages, audio files, video files, text files, messages, loyalty information, discounts, offers, coupons, reviews, feedback, questionnaires, surveys, etc.

The input unit 302 may be an input device configured to receive input from an employee, such as a keyboard, capacitive touch screen, etc. The input unit 302 may receive transaction information input from an employee, such as products or services purchased by the consumer 102. In some embodiments, the input unit 302 may include multiple input devices, such as a keyboard in addition to a reading device (e.g., a bar code scanner). The processing unit 308 may be configured to store the transaction information received by the input unit 302 into the transaction database 114.

The receiving unit 304 may be configured to receive a request from the mobile device 110 for content (e.g., via the network 122). The request may include the location identifier encoded in the machine-readable code 108 displayed at the physical location 106 where the consumer 102 is located. The processing unit 308 may identify transaction information in the transaction database 114 based on the location identifier. In one embodiment, the transmitting unit 306 may transmit at least the transaction amount to the mobile device 110. In another embodiment, the processing unit 308 may identify content in the content database 116 based on the stage of the transaction in the transaction information, and the transmitting unit 306 may transmit the identified content to the mobile device 110.

The receiving unit 304 may be further configured to receive an indication that the financial transaction is to be processed. In some embodiments, the indication may include an updated transaction amount (e.g., based on a gratuity). In such an embodiment, the processing unit 308 may update the transaction amount in the transaction database 114 based on the received updated amount. After the indication that the transaction is to be process has been received, the transmitting unit 306 may submit an authorization request to the processing server 120 to initiate processing of the financial transaction. Methods of submitting an authorization request for processing will be apparent to persons having skill in the relevant art. The display unit 310 may be configured to display information to an employee of the merchant 104, such as products or services entered by the employee via the input unit 302, a notification that an indication that the financial transaction is to be processed, or a notification that the financial transaction has been approved or denied.

### Transaction Database

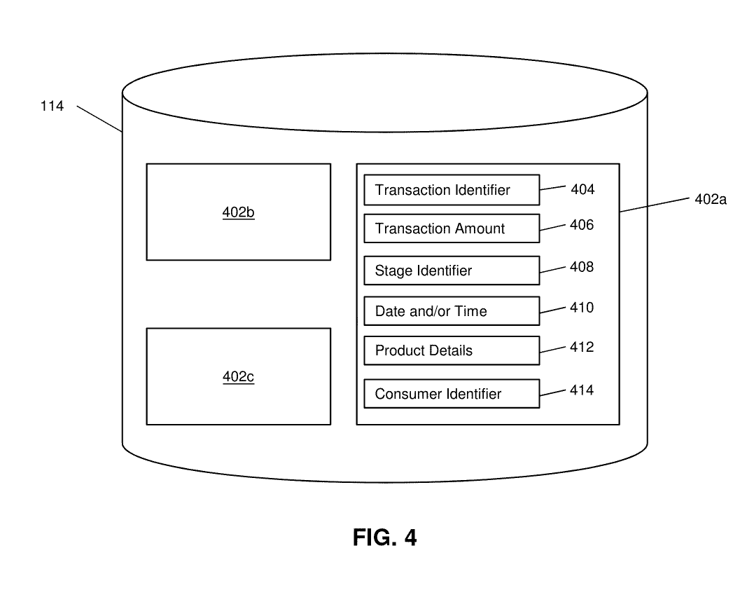

FIG. 4 is an illustration of the transaction database 114 of the merchant server 112 for storing transaction information for financial transactions. The transaction database 114 may include data corresponding to a plurality of transactions 402, illustrated in FIG. 4 as transactions 402a, 402b, and 402c. Each transaction 402 may include at least a transaction identifier 404, a transaction amount 406, and a stage identifier 408. In some embodiments, each transaction 402 may further include a date and/or time 410, product details 412, and a consumer identifier 414.

The transaction identifier 404 may be a unique value associated with the transaction 402, such as for the purposes of identifying the specific financial transaction. In some embodiments, the transaction identifier 404 may also be the location identifier encoded in the machine-readable code 108 displayed at the physical location 106, such that the financial transaction involving any consumer at the physical location 106 will always have the same transaction identifier 404 (though of course both or either the location or the machine readable code 108 can be updated, moved or otherwise changed). In other embodiments, the transaction 402 may further include a location identifier and the transaction identifier 404 may or may not be reused.

The transaction amount 406 may be the amount due (e.g., owed by the consumer 102) for the financial transaction. In some embodiments, the transaction amount 406 may be separated into multiple amounts, such as a subtotal, a total, a tip, a tax amount, etc. The stage identifier 408 may be a number or value that indicates the phase or stage that the transaction 402 is in at the time. In some embodiments, the stage identifier 408 may be used to identify content in the content database 116 to be distributed to the mobile device 110. Stages that a transaction may be separated into may depend on the industry and circumstances of the transaction as will be apparent to persons having skill in the relevant art, and also as discussed in more detail below.

The date and/or time 410 may be the date and/or time at which the financial transaction is taking place. The date and/or time 410 may be a single time (e.g., at the start of the transaction, at the time of payment, at the submission of the authorization request, at the receipt of approval or denial of the transaction, etc.), or may include multiple times. In some embodiments, the date and/or time 410 may be used to identify content in the content database 116 for distribution to the mobile device 110 (e.g., for identifying daily specials to be displayed on the display unit 118 to the consumer 102 prior to ordering food at a merchant restaurant).

The product details 412 may include product information (e.g., name, description, amount, quantity, etc.) for goods or services being purchased by the consumer 102. The product details 412 may include, for example, a line item breakdown of items, their price, and their quantity purchased by the consumer 102. The product details 412 may be distributed to the mobile device 110 along with the transaction amount 406 for presentation along with the transaction amount 406 for approval of the transaction by the consumer 102.

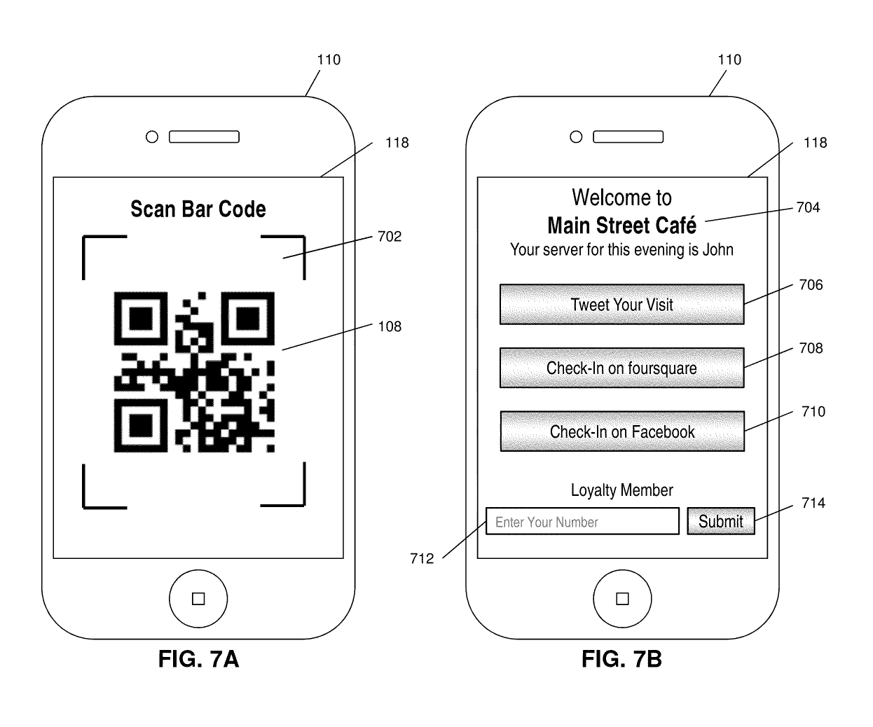

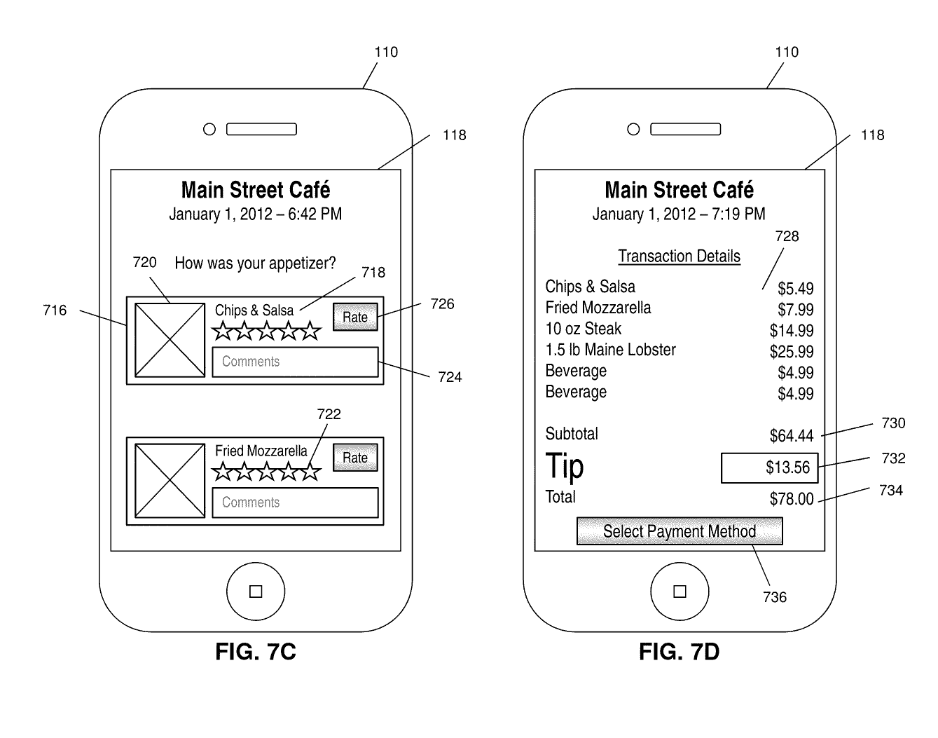

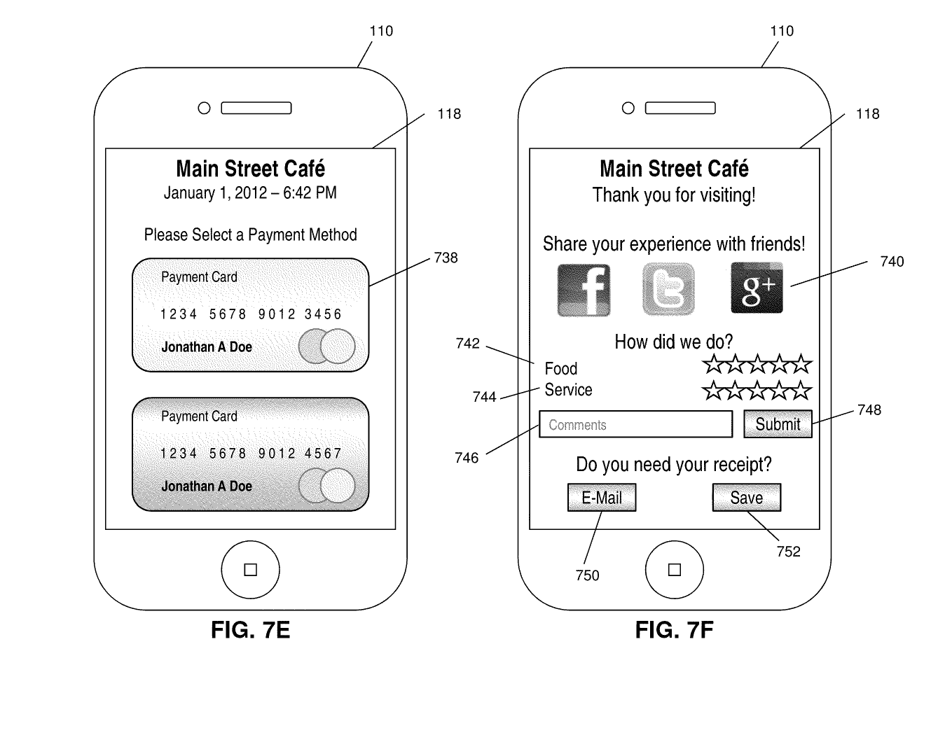

The consumer identifier 414 may be any type of value suitable for identifying the consumer 102, such as a loyalty account number. The merchant server 112 may be able to use the consumer identifier 414 to identify the consumer 102 to provide additional services to the consumer 102. For example, the consumer 102 may earn points or rewards through a loyalty program, which may be distributed to the consumer 102 (e.g., automatically or via a request of the consumer using the mobile device 110), a favorite or “usual” order of the consumer 102 may be stored and automatically entered on the consumer's behalf once they are identified (e.g., by entering loyalty information on the mobile device 110, as illustrated in FIG. 7B, discussed below), etc.

### Method for Distributing Content and Processing an Ongoing Consumer Experience

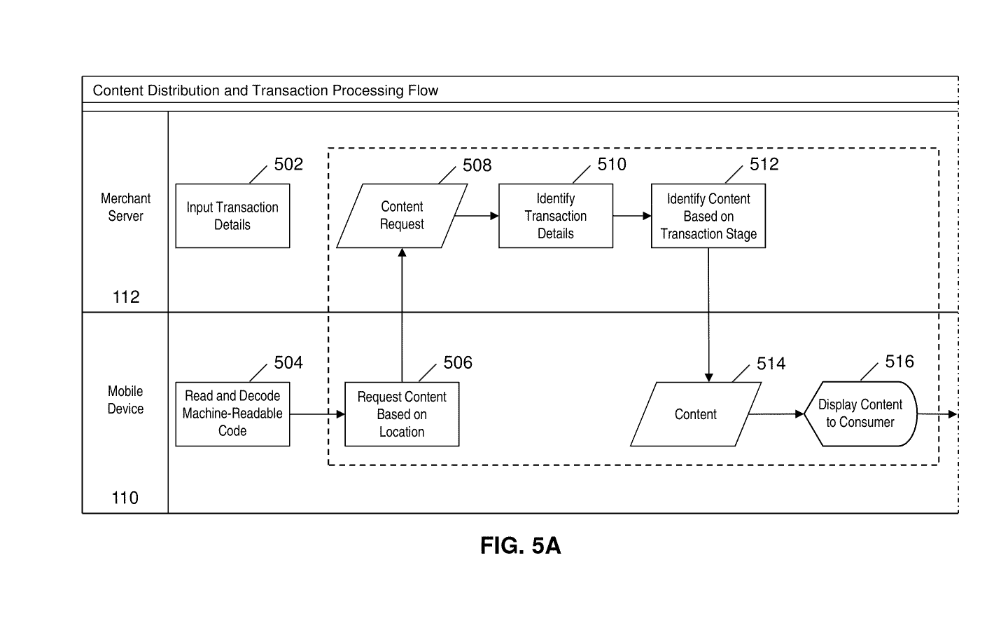

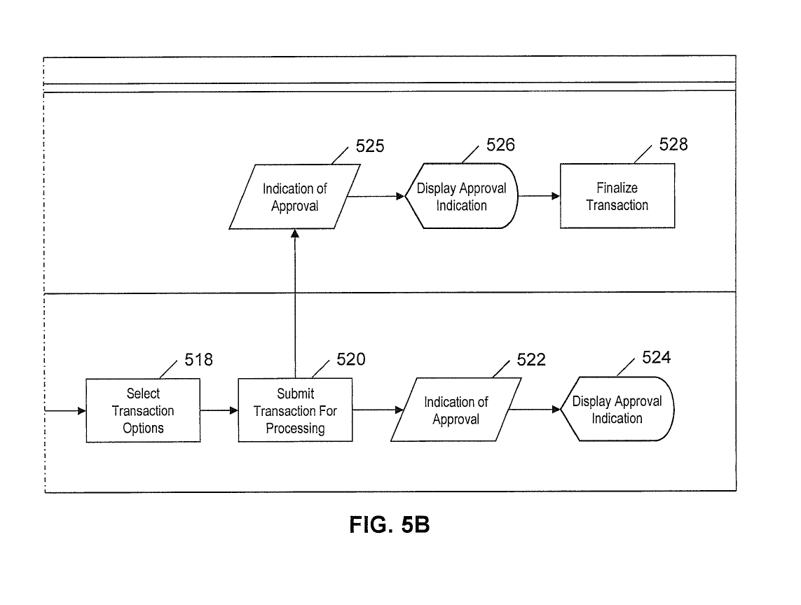

FIGS. 5A and 5B illustrate a processing flow for a method for distributing content to a consumer device during an ongoing financial transaction and processing the financial transaction.

In step 502, an employee of the merchant 104 may enter transaction details into the merchant server 112 (e.g., via the input unit 302). The transaction details may include product information for goods or services being purchased by the consumer 102. In step 504, the consumer 102, present at the physical location 106, may read (e.g., via the reading unit 202) the machine-readable code 108 displayed at the physical location 106 using the mobile device 110. The processing unit 204 may decode the machine-readable code 108 to identify the encoded location identifier.

In step 506, the mobile device may transmit (e.g., via the transmitting unit 206) a request for content based on its location at the physical location 106. The request may include at least the location identifier, but in some embodiments may further include additional information such as the consumer identifier 414. In step 508, the merchant server 112 may receive (e.g., via the receiving unit 304) the content request including at least the location identifier. In step 510, the processing unit 308 may identify transaction details in the transaction database 114 for the financial transaction involving the consumer 102 based on the location identifier.

In step 512, the processing unit 308 may identify content in the content database 116 based on at least the stage identifier 408 included in the identified transaction details. In some embodiments, the content may be further based on the date and/or time 410, the product details 412, the transaction identifier 404, and/or the consumer identifier 414. The transmitting unit 306 of the merchant server 112 may transmit the identified content to the mobile device 110, which may be received by the receiving unit 208 of the mobile device 110 in step 514. In step 516, the display unit 118 of the mobile device 110 may display the received content to the consumer 102.

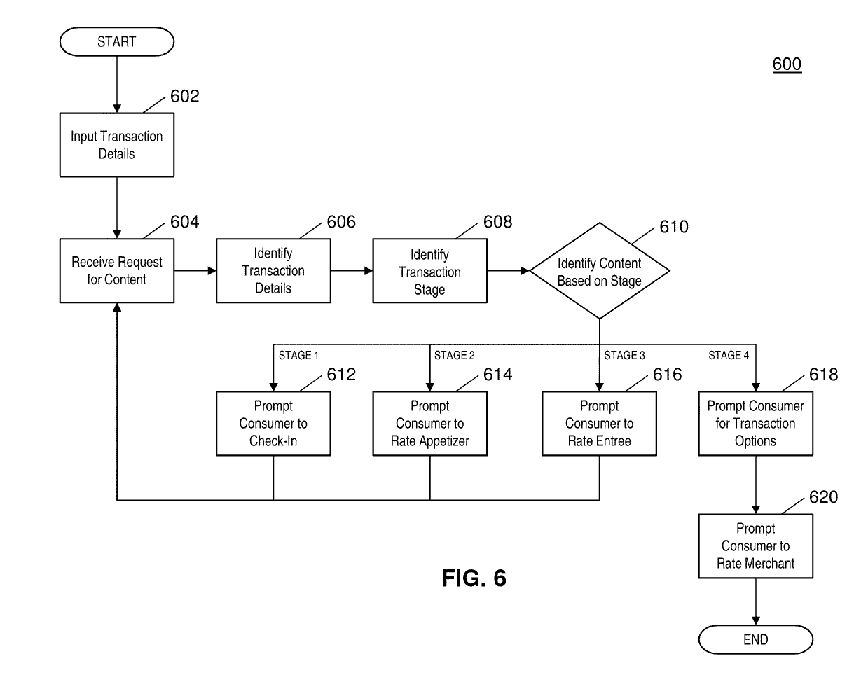

It will be apparent to persons having skill in the relevant art that steps 506 to 516 may be repeated at multiple stages during the financial transaction (e.g., based on the stage identifier 408) to distribute different content to the mobile device 110. An exemplary method for distributing content to the mobile device 110 based on the stage identifier 408 is illustrated in FIG. 6 and described in more detail below. In an exemplary embodiment, the content displayed to the consumer 102 in step 516 may include at least a transaction amount (e.g., the transaction amount 406) to be approved for the financial transaction.

In step 518, the mobile device 110 may (e.g., via the input unit 210) receive an indication of selected transaction options from the consumer 102. The selected transaction options may include at least an approval of the transaction amount 406 for the financial transaction and a funding source, but may in some embodiments further include an updated transaction amount, a tip or gratuity, discounts or offers to be applied, a loyalty number to be credited for the transaction, etc. In step 520, the mobile device 110 may submit (e.g., via the transmitting unit 306) an authorization request for the financial transaction (e.g., to the processing server 120). In some embodiments, the selected transaction options may be transmitted to the merchant server 112, which may submit the authorization request based on the transaction details and the selected transaction options.

In step 522, the mobile device 110 may receive an indication of approval of the transaction from the processing server 120 and/or the merchant server 112. In step 524, the display unit 118 of the mobile device 110 may display the received indication of approval to the consumer 102. In some embodiments, the display unit 118 may present the consumer 102 with additional options regarding the indication of approval, such as for the saving, printing, or distribution of the approval.

In step 524, the merchant server 112 may receive the indication of approval from the processing server 120. Then, in step 526, the display unit 310 of the merchant server 112 may display the indication that the transaction has been approved to the employee. The employee may then, in step 528, finalize the transaction (e.g., by notifying the consumer 102, furnishing goods or services to the consumer 102, etc.).

### Method for Distributing Content Based on a Stage Identifier

FIG. 6 illustrates a method 600 for distributing content during an ongoing consumer experience based on a stage of the consumer experience.

In step 602, an employee of the merchant 104 may input (e.g., via the input unit 302) transaction details for a financial transaction into the merchant server 112. The processing unit 308 of the merchant server 112 may store the transaction details in the transaction database 114. In step 604, the receiving unit 304 may receive a request for content from the mobile device 110 of the consumer 102, the request for content including at least a location identifier corresponding to the physical location 106 and/or the financial transaction.

In step 606, the processing unit 308 may identify the transaction details for the financial transaction 402 involving the consumer 102 in the transaction database 114 using the location identifier. Once the transaction details are identified, the processing unit 308 may identify the stage identifier 408 for the transaction 402 in step 608. In step 610, the processing unit 308 may identify content in the content database 116 based on at least the stage identifier 408. In some embodiments, the identified content may be further based on at least the transaction identifier 404, the transaction amount 406, the date and/or time 410, or the consumer identifier 414 of the transaction 402.

The method 600 illustrated in FIG. 6 is illustrated as having four possibilities for the stage identifier 408. It should be noted that the four possibilities and outcomes are presented for non-limiting exemplary illustration purposes and are not intended to be exhaustive as to the possibilities of the distribution of content to the mobile device 110 based on the stage of the financial transaction 402. The stage identifier 408 may be updated automatically (e.g., by the processing unit 308 based on predetermined criteria, e.g. a timer approximating the typical time spend at a given stage, when a response is received from an earlier stage information request, by the merchant server 112 via wait staff input or service tracking software, or the stage identifier 408 may be updated by a user via the input unit 302.

If the stage identifier 408 indicates that the transaction is in the first stage, such as prior to the ordering of food at a restaurant, then, in step 612, content may be distributed to the mobile device 110 to prompt the consumer 102 to check-in their visit to the merchant 104 on at least one social network (e.g., foursquare, Twitter, Facebook, etc.). If the stage identifier 408 indicates that the transaction is in the second stage, such as after the consumer 102 has received an appetizer, then, in step 614, content may be distributed to the mobile device 110 to prompt the consumer 102 to rate the appetizer, take an image of the appetizer, share the experience through social networking, etc., for instance.

If the stage identifier 408 indicates that the transaction is in the third stage, such as after the consumer 102 has received their entrée, then, in step 616, content may be distributed to prompt the consumer 102 to rate the entrée, for instance. If the stage identifier 408 indicates that the transaction is in the last stage, such as when the consumer 102 is finished with their meal and ready to settle, then, in step 618, the transaction amount may be distributed to the consumer 102 to prompt the consumer to select transaction options and initiate processing of the financial transaction. Once the consumer 102 has selected transaction options, the content may be further configured to, in step 620, prompt the consumer 102 to rate the merchant 104 and share their consumer experience on at least one social network.

### Graphical User Interface for the Mobile Device

FIGS. 7A-7F illustrate exemplary graphical user interfaces displayed by the display unit 118 of the mobile device 110 for the display of content during an non-limiting, exemplary ongoing consumer experience and the processing and sharing of the consumer experience.

FIG. 7A is an illustration of a display for reading the machine-readable code 108 displayed at the physical location 106. The display 118 may include a scanning area 702, which may indicate to the consumer 102 where the machine-readable close 108 should be positioned in order to be read by the reading unit 202. Once the machine-readable code 108 is read, the location identifier decoded, and stage of the transaction determined, the mobile device 110 may receive (e.g., via the receiving unit 208) content.

FIG. 7B is an illustration of content displayed when the transaction 402 is in the first stage as illustrated in FIG. 6. The display 118 may include a merchant name 704 of the merchant 104, which may serve as an indicator to the consumer 102 that the machine-readable code 108 corresponded to the physical location 106 properly. The display 118 may also include buttons 706, 708, and 710, each of which may share the consumer's visit at the merchant 104 with a respective social network when pressed by the consumer 102. In some embodiments, the display 118 may include a loyalty field 712, where the consumer 102 may input loyalty information to submit to the merchant 104, such as their loyalty number for earning points, discounts, etc. The display 118 may also include a submit button 714, which, when interacted with by the consumer 102, may submit the data entered into the loyalty field 712 to the merchant server 112 (e.g., via the transmitting unit 206).

FIG. 7C is an illustration of content displayed on the mobile device 110 when the transaction 402 is indicated as being in the second stage (e.g., based on the stage identifier 408) as illustrated in FIG. 6. The display 118 may include a plurality of appetizers 716 ordered by the consumer 102 in order to receive feedback from the consumer 102. Each appetizer 716 may include a name 718, a picture 720, a rating 722, and a comment field 724. The rating 722, illustrated as up to five stars that the consumer 102 may assign the appetizer 716, may be any type of rating system suitable for rating an ordered item, such as a value out of 4 or 5 stars, a number out of 10, a score from 1 to a predetermined number such as 100, or a Boolean type of rating (e.g., like or do not like).

The consumer 102 may interact with the comment field 724 to provide any detailed comments regarding the appetizer 716, such as a more detailed rating, a review of the food or service in providing the food, comments on taste, etc. In some embodiments, the appetizer 716 may include multiple comment fields 724 for receiving feedback corresponding to multiple aspects of the appetizer 716, as may be determined by the merchant 104, such as one field 724 for comments on the dish itself and another field 724 for comments as to the service provided by the staff in preparing and delivering the dish. It will be apparent that there may also be multiple ratings 722 to be assigned by the consumer 102 for multiple categories in some embodiments. Once the consumer 102 has entered the rating 722 and comments 724, the consumer 102 may interact with the rate button 726, which may submit the provided information to the merchant server 112.

FIG. 7C is an illustration of content displayed on the mobile device 110 when the transaction 402 is indicated as being in the fourth stage as illustrated in FIG. 6. The display 118 may display transaction details for the financial transaction 402. The transaction details may include a product listing 728, which may include a listing of goods or services transacted for by the consumer 102, which may include, for example, product names, product quantities, and product prices. The transaction details may also include a subtotal 730, which may correspond to the transaction amount 406 for the transaction 402 stored in the transaction database 114.

The display 118 may also include a tip field 732, which may be configured to allow the consumer 102 to input (e.g., via the input unit 210) a tip or gratuity to provide to their service provider, which is to be paid in addition to the transaction amount 406. The display 118 may further include a total amount 734, which may be a calculated updated transaction amount based on the subtotal 730 and the tip or gratuity entered into the tip field 732. In an exemplary embodiment, the total amount 734 may automatically update to reflect any change entered into the tip field 732 by the consumer 102. Once the consumer 102 is satisfied with the tip and the total amount 734, they may interact with a select payment button 736, which may cause the display 118 of the mobile device 110 to display the select payment screen as illustrated in FIG. 7E.

The select payment screen may include a plurality of payment methods 738, illustrated in FIG. 7E as two payment cards registered to the consumer 102. The payment method 738 displayed by the display 118 may be a representation of a payment card, financial account (e.g., checking account, debit account, etc.), etc. that the consumer 102 may use to fund the transaction 402. In some embodiments, the display 118 may further include fields to enter a new payment method for funding the transaction 402, or a button to take the consumer 102 to a separate screen to enter in such information. As illustrated in FIG. 7E, each payment method 738 may be configured as a button, which, when interacted with by the consumer 102, may submit the tip entered into the tip field 732 and/or the total amount 734, and the funding details for the selected payment method 738. In one embodiment, the information may be submitted to the merchant server 112. In another embodiment, the mobile device 110 may submit the information directly to the processing server 120 as an authorization request.

FIG. 7F is an illustration of content displayed by the display 118 upon the receipt of an indication of approval for the financial transaction. The display 118 may include sharing buttons 740, which may cause the mobile device 110 to share the consumer's consumer experience with at least one social network. It will be apparent to persons having skill in the relevant art that sharing buttons 740 may be configured to transfer the consumer 102 to a corresponding application program on the mobile device 110, may enable the consumer 102 to share their experience with the corresponding network from within the same application program, or may automatically share a preset submission with the corresponding social network.

The display 118 may also include a brief survey that the consumer 102 may be requested to fill out. The survey may include a food rating 742, a service rating 744, and a comments field 746. The consumer 102 may provide the corresponding information, and then may press a submit button 748 to submit the survey data to the merchant server 112 or a third party service (e.g., a survey provider, etc.). The display 118 may further include an e-mail button 750, which, when pressed by the consumer 102, may e-mail a receipt for the transaction 402 to the consumer 102 (e.g., using a previously entered e-mail address). The display 118 may also include a save button 752 to save a receipt for the transaction 402, which may be saved by an application program (e.g., the application program used to read the machine-readable code 108 and display the content illustrated in FIGS. 7A-7F) for viewing at a later time.

It should be noted that the displays illustrated in FIGS. 7A-7F are presented as illustrations only of a graphical user interface for the carrying out of the methods disclosed herein on the mobile device 110 and are not exhaustive of all of the possible graphical user interfaces or methods for displaying content received by the mobile device 110. Additional interfaces, screens, and information to be displayed or input via the mobile device 110 will be apparent to persons having skill in the relevant art.

### Computer System Architecture

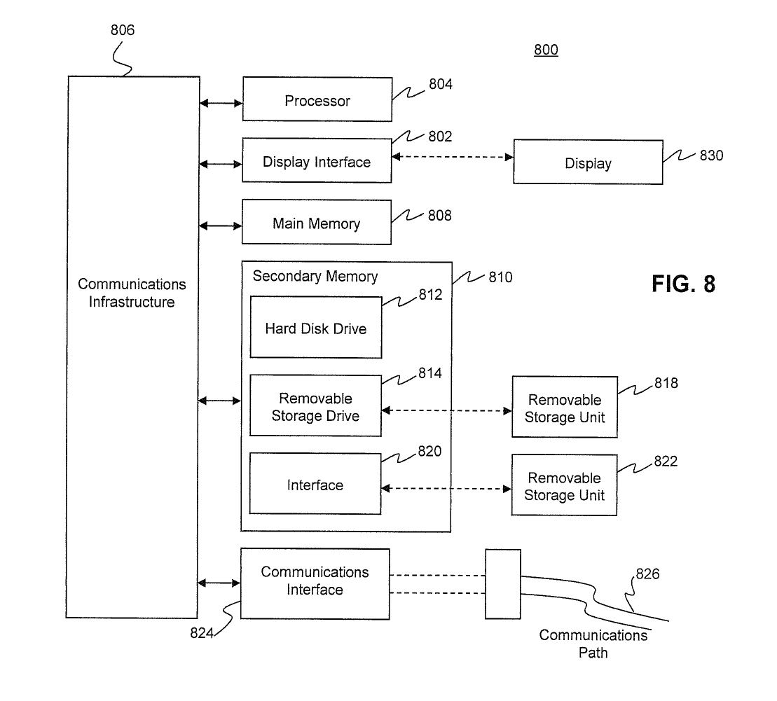

FIG. 8 illustrates a computer system 800 in which embodiments of the present disclosure, or portions thereof, may be implemented as computer-readable code. For example, the mobile device 110, the processing server 120, and the merchant server 112 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 5A, 5B, 6, 9, and 10.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network (e.g., the network 122), multi-core message-passing scheme, etc. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 5A, 5B, 6, 9, and 10, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

### Exemplary Method for Funding and Sharing a Consumer Experience

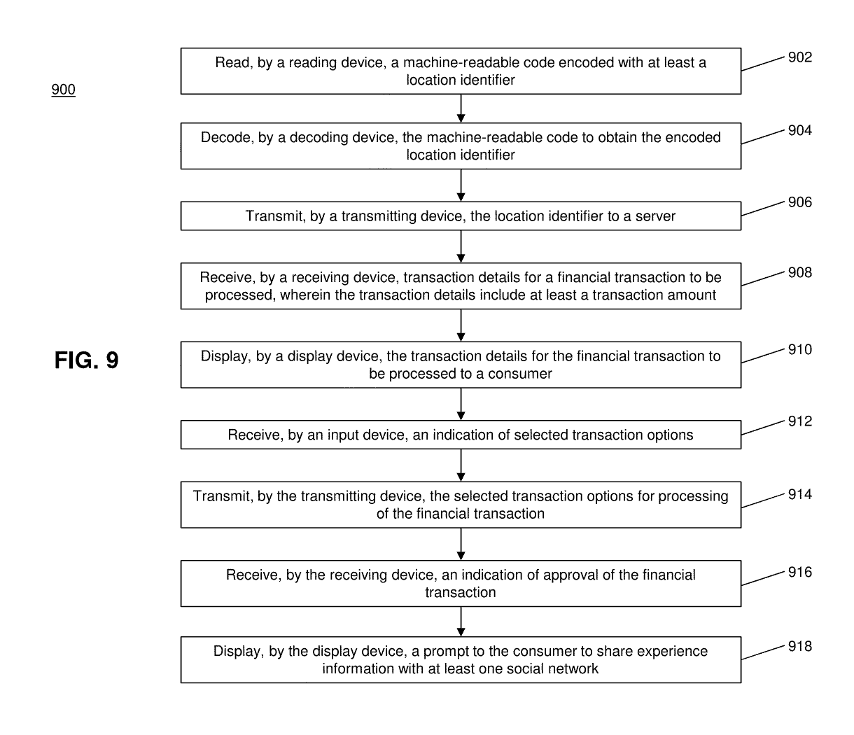

FIG. 9 illustrates a method 900 for funding and sharing a consumer experience via a mobile device (e.g., the mobile device 110).

In step 902, a machine-readable code (e.g., the machine-readable code 108) encoded with a location identifier may be read by a reading device (e.g., the reading unit 202). In one embodiment, the machine-readable code 108 may be a bar code. In a further embodiment, the bar code may be a QR code. In some embodiments, the machine-readable code 108 may be displayed at a physical location (e.g., the physical location 106) associated with the encoded location identifier.

In step 904, the machine-readable code 108 may be decoded by a decoding device (e.g., the processing unit 204), to obtain the encoded location identifier. Then, in step 906, the location identifier may be transmitted, by a transmitting device (e.g., the transmitting unit 206), to a server (e.g., the merchant server 112). In step 908, a receiving device (e.g., the receiving unit 208) may receive transaction details for a financial transaction to be processed (e.g., the transaction 402), wherein the transaction details include at least a transaction amount (e.g., the transaction amount 406). In one embodiment, the transaction details may further include at least one product to be purchased and an amount associated with the at least one product to be purchased.

In step 910, a display device (e.g., the display unit 118) may display the transaction details for the financial transaction to be processed 402 to a consumer (e.g., the consumer 102). In step 912, an indication of selected transaction options may be received by an input device (e.g., the input unit 210). In one embodiment, the selected transaction options may include at least funding details for funding the financial transaction 402. In step 914, the selected transaction options may be transmitted, by the transmitting device 206, for the processing of the financial transaction 402. In one embodiment, the selected transaction options may include at least a tip amount, and the financial transaction 402 may be processed for an updated transaction amount including the selected tip amount.

In step 916, an indication of approval for the financial transaction 402 may be received by the receiving device 208. In step 918, a prompt may be displayed, by the display device 118, to the consumer to share experience information with at least one social network. In one embodiment, the experience information may include at least one of: a rating, a review, and an identification of at least one employee involved in the financial transaction 402.

### Exemplary Method for Distributing Content During an Ongoing Transaction

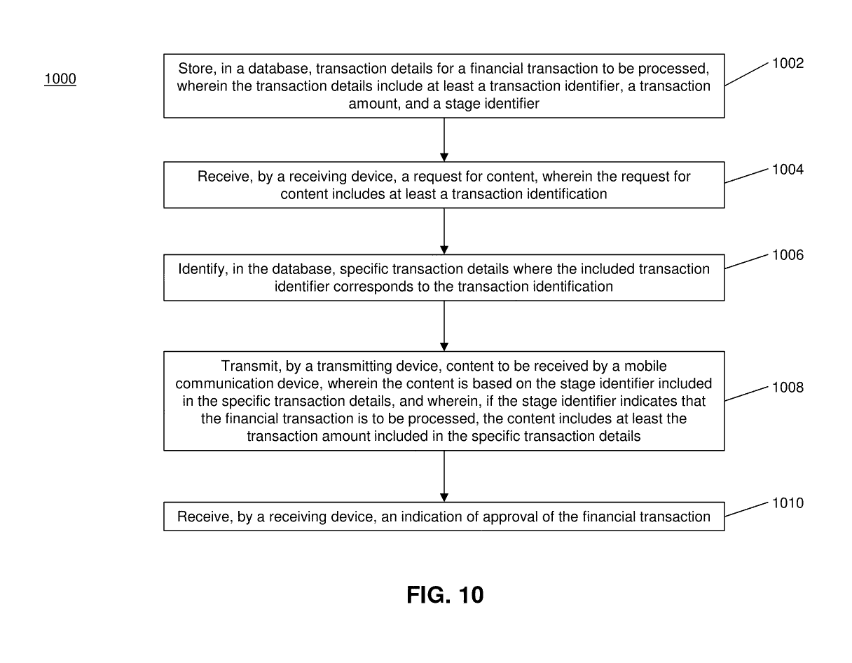

FIG. 10 illustrates a method 1000 for distributing content to a mobile device (e.g., the mobile device 110) during an ongoing transaction.

In step 1002, transaction details for a financial transaction to be processed (e.g., the transaction 402) may be stored in a database (e.g., the transaction database 114), wherein the transaction details include at least a transaction identifier (e.g., the transaction identifier 404), a transaction amount (e.g., the transaction amount 406), and a stage identifier (e.g., the stage identifier 408). In one embodiment, the transaction identifier 404 may be a location identifier. In a further embodiment, the location identifier may be associated with a physical location (e.g., the physical location 106) at which a machine-readable code (e.g., the machine-readable code 108) encoded with the location identifier is displayed. In step 1004, a request for content may be received by a receiving device (e.g., the receiving unit 304), wherein the request for content includes at least a transaction identification.

In step 1006, specific transaction details may be identified in the database 114 where the included transaction identifier 404 corresponds to the transaction identification. In step 1008, a transmitting device (e.g., the transmitting unit 306), may transmit content to be received by a mobile communication device (e.g., the mobile device 110), wherein the content is based on the stage identifier 408 included in the specific transaction details, and wherein, if the stage identifier 408 indicates that the financial transaction 402 is to be processed, the content includes at least the transaction amount 406 included in the specific transaction details. In one embodiment, the content may include at least one of: a website address, an executable command, a machine-readable code, a message, and a prompt. In a further embodiment, the executable command may be configured to cause the mobile communication device 110 to prompt a user to share experience information with at least one social network.

In step 1010, an indication of approval of the financial transaction 402 may be received by a receiving device (e.g., the receiving unit 304). In some embodiments, the method 1000 may further include receiving, by the receiving device 304, selected transaction options for the financial transaction to be processed 402, the selected transaction options include at least a confirmed transaction amount, and transmitting, by the transmitting device 306, an authorization request for the financial transaction for the confirmed transaction amount, wherein the indication of approval for the financial transaction received in step 1010 is received in response to the transmitting of the authorization request. In a further embodiment, the selected transaction options may further include funding details for funding the financial transaction 402.

Techniques consistent with the present disclosure provide, among other features, systems and methods for the funding and sharing of a consumer experience and distribution of content during the ongoing transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for funding and sharing a consumer experience, comprising:
reading, by a reading device, a machine-readable code encoded with at least a location identifier;
decoding, by a decoding device, the machine-readable code to obtain the encoded location identifier;
transmitting, by a transmitting device, the location identifier to a server;
receiving, by a receiving device, transaction details for a financial transaction to be processed, wherein the transaction details include at least a transaction amount;
displaying, by a display device, the transaction details for the financial transaction to be processed to a consumer;
receiving, by an input device, an indication of selected transaction options;
transmitting, by the transmitting device, the selected transaction options for processing of the financial transaction;
receiving, by the receiving device, an indication of approval of the financial transaction; and
displaying, by the display device, a prompt to the consumer to share experience information with at least one social network.

2. The method of claim 1, wherein the machine-readable code is a bar code.

3. The method of claim 2, wherein the bar code is a QR code.

4. The method of claim 1, wherein the machine-readable code is displayed at a physical location associated with the location identifier.

5. The method of claim 1, wherein the transaction details further include at least one product to be purchased and an amount associated with the at least one product to be purchased.

6. The method of claim 1, wherein the selected transaction options include at least funding details for funding the financial transaction.

7. The method of claim 1, wherein the selected transaction options include at least a tip amount, and wherein the financial transaction is processed for an updated transaction amount including the selected tip amount.

8. The method of claim 1, wherein the experience information includes at least one of: a rating, a review, and an identification of at least one employee involved in the financial transaction.

9. A method for distributing content during an ongoing transaction, comprising:
storing, in a database, transaction details for a financial transaction to be processed, wherein the transaction details include at least a transaction identifier, a transaction amount, and a stage identifier;
receiving, by a receiving device, a request for content, wherein the request for content includes at least a transaction identification;
identifying, in the database, specific transaction details where the included transaction identifier corresponds to the transaction identification;
transmitting, by a transmitting device, content to be received by a mobile communication device, wherein the content is based on the stage identifier included in the specific transaction details, and wherein, if the stage identifier indicates that the financial transaction is to be processed, the content includes at least the transaction amount included in the specific transaction details; and
receiving, by the receiving device, an indication of approval of the financial transaction.

10. The method of claim 9, further comprising:
receiving, by the receiving device, selected transaction options for the financial transaction to be processed, wherein the selected transaction options include at least a confirmed transaction amount; and
transmitting, by the transmitting device, an authorization request for the financial transaction, wherein the authorization request is for the confirmed transaction amount,
wherein the indication of approval of the financial transaction is received in response to the transmitting of the authorization request.

11. The method of claim 10, wherein the selected transaction options further include at least funding details for funding the financial transaction.

12. The method of claim 9, wherein the content includes at least one of: a website address, an executable command, a machine-readable code, a message, and a prompt.

13. The method of claim 12, wherein the executable command is configured to cause the mobile communication device to prompt a user to share experience information with at least one social network.

14. The method of claim 9, wherein the transaction identifier is a location identifier.

15. The method of claim 14, wherein the location identifier is associated with a physical location at which a machine-readable code encoded with the location identifier is displayed.

16. A system for funding and sharing a consumer experience, comprising:
a reading device configured to read a machine-readable code encoded with at least a location identifier;
a decoding device configured to decode the machine-readable code to obtain the encoded location identifier;
a transmitting device configured to transmit the location identifier to a server;
a receiving device configured to receive transaction details for a financial transaction to be processed, wherein the transaction details include at least a transaction amount;
a display device configured to display the transaction details for the financial transaction to be processed to a consumer; and
an input device configured to receive an indication of selected transaction options, wherein
the transmitting device is further configured to transmit the selected transaction options for processing of the financial transaction,
the receiving device is further configured to receive an indication of approval of the financial transaction, and
the display device is further configured to display a prompt to the consumer to share experience information with at least one social network.

17. The system of claim 16, wherein the machine-readable code is a bar code.

18. The system of claim 17, wherein the bar code is a QR code.

19. The system of claim 16, wherein the machine-readable code is displayed at a physical location associated with the location identifier.

20. The system of claim 16, wherein the transaction details further include at least one product to be purchased and an amount associated with the at least one product to be purchased.

21. The system of claim 16, wherein the selected transaction options include at least funding details for funding the financial transaction.

22. The system of claim 16, wherein the selected transaction options include at least a tip amount, and wherein the financial transaction is processed for an updated transaction amount including the selected tip amount.

23. The system of claim 16, wherein the experience information includes at least one of: a rating, a review, and an identification of at least one employee involved in the financial transaction.

24. A system for distributing content during an ongoing transaction, comprising:
a database configured to store transaction details for a financial transaction to be processed, wherein the transaction details include at least a transaction identifier, a transaction amount, and a stage identifier;
a receiving device configured to receive a request for content, wherein the request for content includes at least a transaction identification;
a processing device configured to identify, in the database, specific transaction details where the included transaction identifier corresponds to the transaction identification; and
a transmitting device configured to transmit content to be received by a mobile communication device, wherein the content is based on the stage identifier included in the specific transaction details, and wherein, if the stage identifier indicates that the financial transaction is to be processed, the content includes at least the transaction amount included in the specific transaction details,
wherein the receiving device is further configured to receive an indication of approval of the financial transaction.

25. The system of claim 24, wherein
the receiving device is further configured to receive selected transaction options for the financial transaction to be processed, the selected transaction options including at least a confirmed transaction amount,
the transmitting device is further configured to transmit an authorization request for the confirmed transaction amount for the financial transaction, and
the receiving device is further configured to receive the indication of approval of the financial transaction in response to the transmitting device transmitting the authorization request.

26. The system of claim 25, wherein the selected transaction options further include at least funding details for funding the financial transaction.

27. The system of claim 24, wherein the content includes at least one of: a website address, an executable command, a machine-readable code, a message, and a prompt.

28. The system of claim 27, wherein the executable command is configured to cause the mobile communication device to prompt a user to share experience information with at least one social network.

29. The system of claim 24, wherein the transaction identifier is a location identifier.

30. The system of claim 29, wherein the location identifier is associated with a physical location at which a machine-readable code encoded with the location identifier is displayed.
